(19) United States
(12) Patent Application Publication
(10) Pub. No.: US 2020/0412002 A1
(43) Pub. Date: Dec. 31, 2020

(54) Antenna Element and Array Antenna

(71) Applicant: AAC Technologies Pte. Ltd., Singapore city (SG)

(72) Inventors: Lulong Li, Shenzhen (CN); Hua Jiang, Shenzhen (CN); Jianpeng Zhu, Shenzhen (CN)

(21) Appl. No.: 16/996,903

(22) Filed: Aug. 19, 2020

Related U.S. Application Data
(63) Continuation of application No. PCT/CN2019/094041, filed on Jun. 30, 2019.

(51) Int. Cl. H01Q 13/18; H01Q 21/00; H01Q 21/06; H01Q 21/24

(52) U.S. Cl. CPC H01Q 13/18; H01Q 21/24; H01Q 21/065; H01Q 21/0043

(57) ABSTRACT

The invention provides an antenna element including: a radiation sheet with a first surface and a second surface arranged opposite to the first surface, and a plurality of hollowed parts penetrating through the first surface and the second surface; a plurality of feeder branches each having one end connected with a side wall of the corresponding hollow part and another end extending from the first surface far away from the first surface. Wherein the radiation sheet and the feeder branches are integrally formed by stamping, so that the antenna element provided by the invention is simple in manufacturing and the cost can be effectively reduced. Moreover, the stamped and formed antenna element can have the advantages of a smaller thickness and light weight, and large-scale array forming is facilitated.

### FIELD OF THE PRESENT DISCLOSURE

The invention relates to the field of antennas, in particular to an antenna element and an array antenna of using the antenna element.

### DESCRIPTION OF RELATED ART

5G, as a next-generation communication technology, has a profound influence and great significance. With the development of communication technologies, advanced requirements, such as a broadband, a low profile, light weight and low cost, on an antenna of a base station are presented. Antenna elements of a conventional base station are generally manufactured and formed by a metal die-casting process or a PCB process. However, as the number of the antenna elements of a 5G base station has increased exponentially, the antenna elements manufactured by the metal die-casting process and the antenna elements manufactured by the PCB process have some advantages. The antenna elements manufactured by the metal die-casting process are overloaded and not favorable for large-scale array forming, while the vibrators manufactured by the PCB process have more components and more solder joints, and are not favorable for assembly.

Therefore, it is necessary to provide a novel antenna element to solve the problems.

### SUMMARY OF THE INVENTION

One of the main objects of the invention is to provide an antenna element with smaller profile and reduced cost.

Therefore, the invention provides an antenna element including: a radiation sheet with a first surface and a second surface arranged opposite to the first surface, and a plurality of hollowed parts penetrating through the first surface and the second surface; a plurality of feeder branches each having one end connected with a side wall of the corresponding hollow part and another end extending from the first surface far away from the first surface.

Further, the radiation sheet is in a square form, and comprises two mutually perpendicular diagonal lines and forms two groups of vibrator units with orthogonal polarization directions along the two diagonal lines.

Further, four hollowed parts and four feeder branches are arranged; two hollowed parts are arranged on each diagonal line at an interval; and the side wall of each hollowed part is connected with one feeder branch.

Further, the antenna element comprises a radiation branch, one end thereof connected with the end parts of the vibrator units and the other end thereof extending from the first surface far away from the first surface.

Further, the radiation sheet, the feeder branches and the radiation branch are integrally formed by stamping.

Further, a distance from the end part of each feeder branch, far away from the first surface, to the first surface is greater than that from the end part of the radiation branch to the first surface far away from the first surface.

Further, the radiation branch comprises a first branch part and a second branch part; the first branch part extends in a bent manner from the end part of each vibrator unit to the side on which the first surface is positioned; and the second branch part extends in a bent manner from the end part of the first branch part to each feeder branch far away from the vibrator unit.

The invention further provides an array antenna, comprising a feeding board and a plurality of antenna elements as described above, wherein the feeding board is provided with a feeding network; and the feeder branches are electrically connected with the feeding network.

In addition, the feeding network comprises a plurality of one-into-three power dividers; and each one-into-three power divider is electrically connected with three antenna elements.

In addition, each one-into-three power divider comprises a radio frequency end and three unit circuits extending from a branch of the radio frequency end; each unit circuit comprises a differential pair; and two ends of each differential pair are electrically connected with two feeder branches separately.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure.

FIG. 1 is an isometric view of an antenna element in accordance with an exemplary embodiment of the invention, showing a front surface.

FIG. 2 is an isometric view of the antenna element, showing a rear surface of the antenna element.

FIG. 3 is an isometric view of an antenna array in the embodiment.

FIG. 4 is a first exploded view of the antenna array.

FIG. 5 is a second exploded view of the antenna array.

FIG. 6 is an isometric view of the antenna array showing a rear surface.

FIG. 7 is an enlarged view of Part A in FIG. 6.

FIG. 8 is a voltage standing wave ratio (VSWR) simulation schematic view of the antenna array.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

It is to be noted that all directional indicators in the embodiments of the invention (for example, upper, lower, left, right, front, back, inner, outer, top, bottom and the like) are only used for explaining relative position relationships among parts in some special gesture (for example, shown in the drawings) and so on. If the special gesture changes, the directional indicators also change correspondingly.

It should also be noted that when an element is referred to as being “fixed” or “disposed” on another element, the element may be directly on the other element or there may be intervening elements at the same time. When an element is called “connected” to another element, it may be directly connected to the other element or there may be intervening elements at the same time.

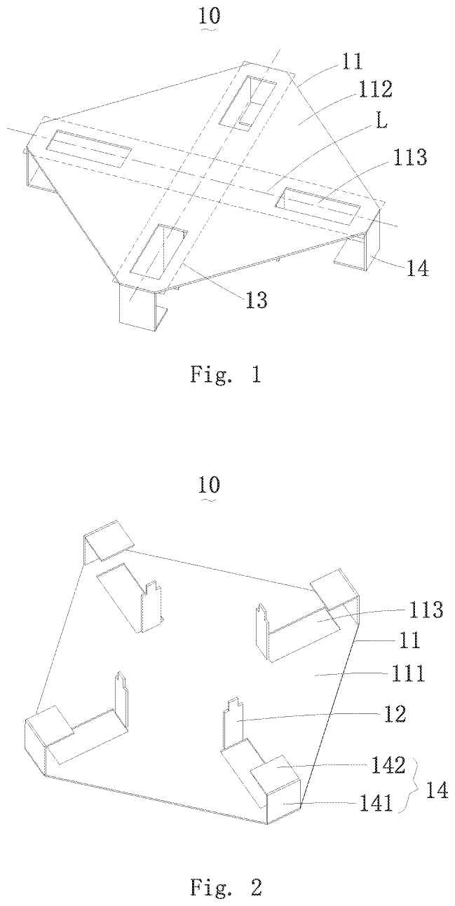

Referring to FIGS. 1 and 2, an antenna element 10, provided by the embodiment of the invention, comprises a radiation sheet 11 and feeder branches 12. The radiation sheet 11 is provided with a first surface 111 and a second surface 112 arranged opposite to the first surface 111. The radiation sheet 11 is provided with hollowed parts 113 penetrating through the first surface 111 and the second surface 112. One end of each feeder branch 12 is connected with a side wall of the corresponding hollow part 113 and the other end extends from the first surface 111 to the direction far away from the first surface 111. The radiation sheet 11 and the feeder branches 12 are integrally stamped and formed by profiles.

The radiation sheet 11 and the feeder branches 12 are integrally stamped and formed by the profiles, so that manufacturing is simple and the cost can be effectively reduced. Moreover, the stamped and formed antenna element 10 can have the advantages of a smaller thickness and light weight, and large-scale array forming is facilitated. In addition, the stamped and formed antenna element 10 has fewer solder joints and is easy to assemble.

As an improvement of the embodiment, the radiation sheet 11 is in a square form. The radiation sheet 11 comprises two mutually perpendicular diagonal lines L. The radiation sheet 11 forms two groups of vibrator units 13 with orthogonal polarization directions along the two diagonal lines. The polarization directions of two vibrator units 13 separately correspond to two polarization directions of +45 degrees and −45 degrees.

As an improvement of the embodiment, four hollowed parts 113 and four feeder branches 12 are arranged; two hollowed parts 113 are arranged on each diagonal line L at an interval; and the side wall of each hollowed part 113 is connected with one feeder branch 12. Preferably, two hollowed parts 113 arranged along the same diagonal line L are arranged symmetrically with respect to a midpoint of the radiation sheet 11. Preferably, projection profiles of the hollowed parts 113 in a direction perpendicular to the second surface 112 are rectangles; symmetrical lines of the hollowed parts 113 in the length direction thereof coincide with the corresponding diagonal lines L. Preferably, the lengths of the feeder branches 12 are consistent with those of the hollowed parts 113 in the length direction thereof, and the hollowed parts 113 are formed while the profiles are stamped to form the feeder branches 12. Through the arrangement of the four feeder branches 12, the four feeder branches 12 can play a relatively good support role in the radiation sheet 11. Through the arrangement of the hollowed parts 113, the edges of the hollowed parts 113 can generate a capacitance effect, thereby facilitating extension of an operating band of the antenna element 10 towards a higher band.

As an improvement of the embodiment, the antenna element 10 further comprises a radiation branch 14. One end of the radiation branch 14 is connected with the end parts of the vibrator units 13 and the other end extends from the first surface 111 to the direction far away from the first surface 111. The radiation branch 14 is arranged to play a role in prolonging electrical lengths of the vibrator units 13.

As an improvement of the embodiment, the radiation sheet 11, the feeder branches 12 and the radiation branch 14 are integrally stamped and formed by the profiles.

As an improvement of the embodiment, the distance from the end part, far away from the first surface 111, of each feeder branch 12 to the first surface 111 is greater than that from the end part, far away from the first surface 111, of the radiation branch 14 to the first surface 111. That is, when the end part, far away from the first surface 111, of the feeder branch 12 is connected with a feeding board, the radiation branch 14 can be in a floating state.

As an improvement of the embodiment, the radiation branch 14 comprises a first branch part 141 and a second branch part 142. The first branch part 141 extends in a bent manner from the end part of each vibrator unit 13 to the side on which the first surface 111 is positioned. The second branch part 142 extends in a bent manner from the end part, far away from each vibrator unit 13, of the first branch part 141 to each feeder branch 12.

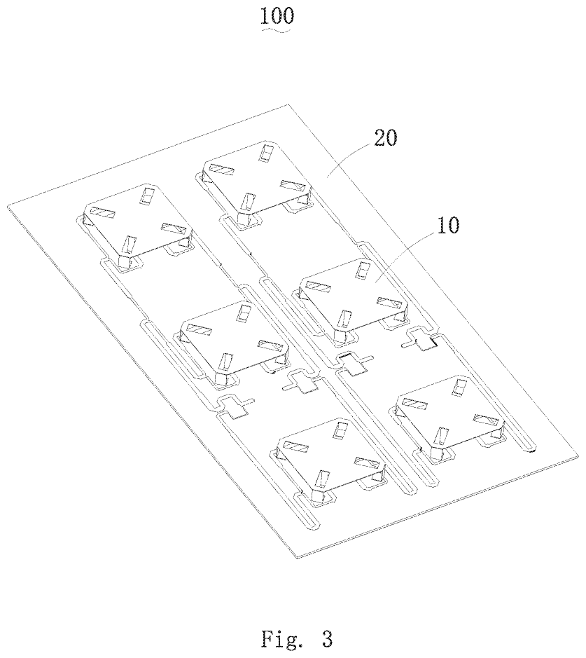

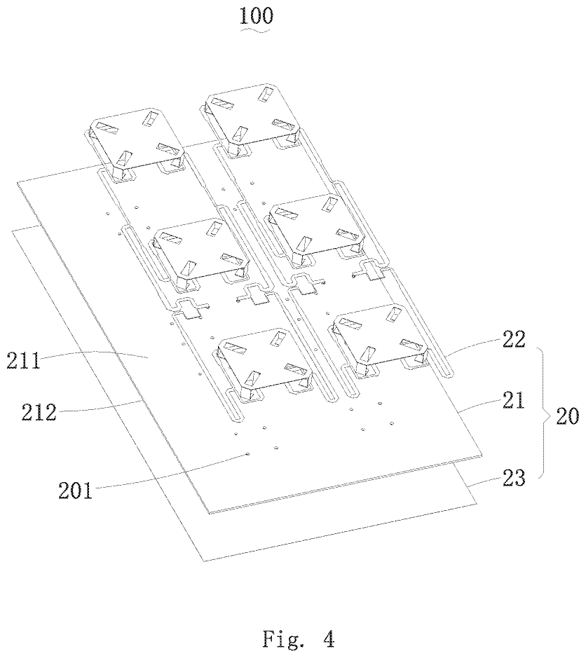

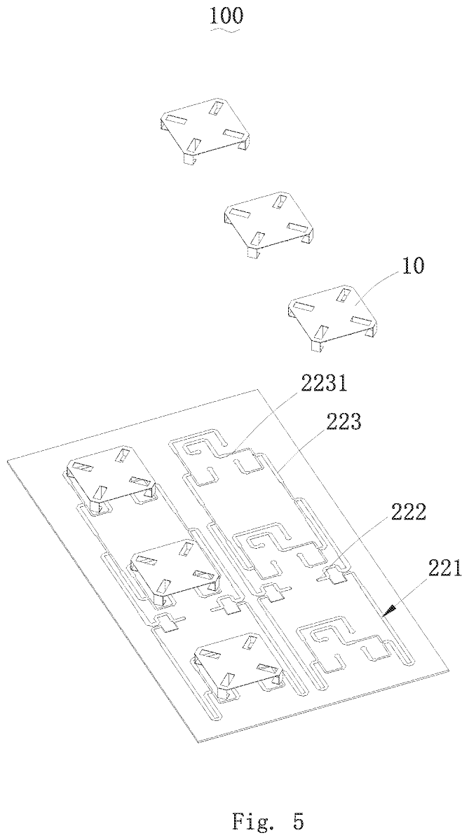

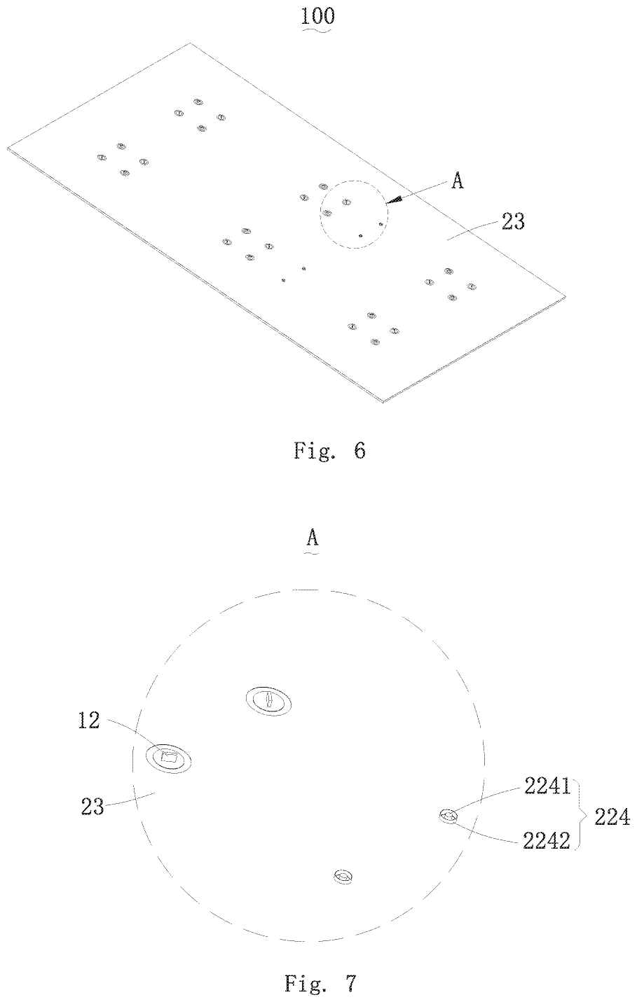

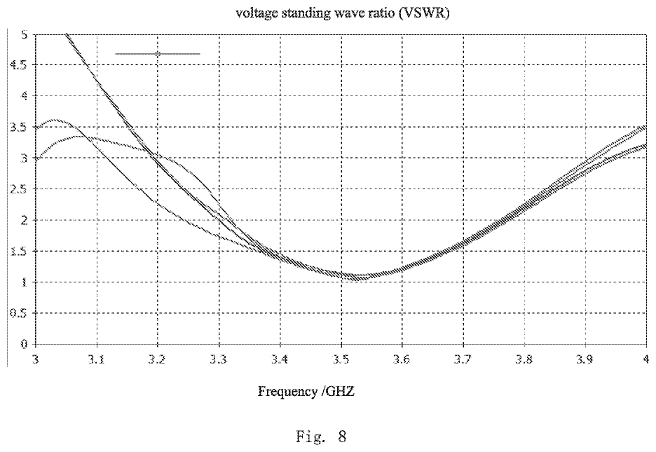

Referring to FIGS. 3-7, an array antenna 100, provided by the embodiment of the invention, comprises the feeding board 20 and a plurality of antenna elements 10. The feeding board 20 comprises an insulation board 21, a feeding network 22 and a grounding layer 23. The insulation board 21 comprises a third surface 211 and a fourth surface 212. The feeding network 22 is arranged on the third surface 211 of the insulation board 21. The grounding layer 23 is arranged on the fourth surface 212 of the insulation board 21. One end, far away from the first surface 111, of each feeder branch 12 is electrically connected with the feeding network 21. Preferably, the feeding network 21 is of a microstrip line structure.

It should be noted that, the capacitance effect can be formed between the second branch part 142 of the radiation branch 14 and the grounding layer 23, so that the operating band of the array antenna 100 is extended towards a lower band and the band of the array antenna 100 is extended.

As an improvement of the embodiment, the feeding network 22 comprises a plurality of one-into-three power dividers 221, and each one-into-three power divider 221 is electrically connected with three antenna elements 10. Specifically, each one-into-three power divider 221 comprises a radio frequency end 222 and three unit circuits 223 extending from a branch of the radio frequency end 222; each unit circuit 223 comprises a differential pair 2231; and two ends of each differential pair 2231 are electrically connected with two feeder branches 12 arranged on the same diagonal line separately.

Each radio frequency end 222 is connected with one coaxial connector 224. Each coaxial connector 224 comprises a first conductive member 2241 and a second conductive member 2242 which is coaxially arranged apart from the first conductive member 2241. Through holes penetrating through the third surface 211 and the fourth surface 212 are formed in the positions of the radio frequency ends 222 on the insulation board 21. The first conductive members 2241 separately pass through the through holes and are connected with the radio frequency ends 222. The second conductive members 2242 are separately arranged on inner side walls of the through holes in a surrounding manner and are connected with the grounding layer 23.

As an improvement of the embodiment, a plurality of mounting holes 201 are formed in the feeding board 20; and one end, far away from the radiation sheet 11, of each feeder branch 12 passes through one mounting hole 201 and is fixed to the feeding board 20 in a welding manner. Welding sites and the grounding layer 23 are separately arranged. It should be noted that the feeder branches 12 and the feeding board 20 are not limited to the use of the mounting and fixing way, for example, the feeding network 22 is provided with a bonding pad, and the feeder branches 12 can also be fixed to a patch of the bonding pad.

Referring to FIG. 8, FIG. 8 shows a voltage standing wave ratio of less than 1.5 of the array antenna 100 within the band of 3.4 GHz to 3.6 GHz and illustrates that the antenna element 100 has relatively good signal receiving and sending effects within the band and has a relatively wide operating band and the operating band thereof can cover the band.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. An antenna element, comprising:
a radiation sheet with a first surface and a second surface arranged opposite to the first surface, and a plurality of hollowed parts penetrating through the first surface and the second surface;
a plurality of feeder branches each having one end connected with a side wall of the corresponding hollow part and another end extending from the first surface far away from the first surface; wherein
the radiation sheet and the feeder branches are integrally formed by stamping.

2. The antenna element as described in claim 1, wherein the radiation sheet is in a square form, and comprises two mutually perpendicular diagonal lines and forms two groups of vibrator units with orthogonal polarization directions along the two diagonal lines.

3. The antenna element as described in claim 2, wherein four hollowed parts and four feeder branches are arranged; two hollowed parts are arranged on each diagonal line at an interval; and the side wall of each hollowed part is connected with one feeder branch.

4. The antenna element as described in claim 2, further comprising a radiation branch, one end thereof connected with the end parts of the vibrator units and the other end thereof extending from the first surface far away from the first surface.

5. The antenna element as described in claim 4, wherein the radiation sheet, the feeder branches and the radiation branch are integrally formed by stamping.

6. The antenna element as described in claim 4, wherein a distance from the end part of each feeder branch, far away from the first surface, to the first surface is greater than that from the end part of the radiation branch to the first surface far away from the first surface.

7. The antenna element as described in claim 4, wherein the radiation branch comprises a first branch part and a second branch part; the first branch part extends in a bent manner from the end part of each vibrator unit to the side on which the first surface is positioned; and the second branch part extends in a bent manner from the end part of the first branch part to each feeder branch far away from the vibrator unit.

8. An array antenna, comprising a feeding board and a plurality of antenna elements as described in claim 1, wherein the feeding board is provided with a feeding network; and the feeder branches are electrically connected with the feeding network.

9. The array antenna as described in claim 8, wherein the feeding network comprises a plurality of one-into-three power dividers; and each one-into-three power divider is electrically connected with three antenna elements.

10. The array antenna as described in claim 9, wherein each one-into-three power divider comprises a radio frequency end and three unit circuits extending from a branch of the radio frequency end; each unit circuit comprises a differential pair; and two ends of each differential pair are electrically connected with two feeder branches separately.
